(19) United States
(12) Patent Application Publication
(10) Pub. No.: US 2010/0153210 A1
(43) Pub. Date: Jun. 17, 2010

(54) APPARATUS AND METHOD FOR SELECTING ONLINE ADVERTISEMENT BASED ON CONTENTS SENTIMENT AND INTENTION ANALYSIS

(75) Inventors: Hyo-Jung OH, Daejeon (KR); Chung Hee Lee, Daejeon (KR); Chang Ki Lee, Daejeon (KR); Myung Gil Jang, Daejeon (KR); HyunKi Kim, Daejeon (KR); Soojong Lim, Daejeon (KR); Jeong Heo, Daejeon (KR); Yi Gyu Hwang, Daejeon (KR); Yeo Chan Yoon, Daejeon (KR); Miran Choi, Daejeon (KR)

Correspondence Address: STAAS & HALSEY LLP, SUITE 700, 1201 NEW YORK AVENUE, N.W., WASHINGTON, DC, 20005, US

(73) Assignee: ELECTRONICS AND TELECOMMUNICATIONS RESEARCH INSTITUTE, Daejeon (KR)

(21) Appl. No.: 12/537,542

(22) Filed: Aug. 7, 2009

(30) Foreign Application Priority Data
Dec. 15, 2008 (KR) 10-2008-0126925

(51) Int. Cl. G06Q 30/00

(52) U.S. Cl. 705/14.52; 705/14.49

(57) ABSTRACT

The invention provides an apparatus and method for selecting an online advertisement. An apparatus for selecting an online advertisement based on contents sentiment and intention analysis includes a context analysis unit for analyzing a context of contents, a context matching advertisement recommendation unit for selecting an advertisement matching with the context of the contents from an advertisement database (DB) based on the result of the analyzed context, an sentiment information analysis unit for analyzing an sentiment object and sentiment information variously described in the contents based on the result of the analyzed context, an intention recognition unit for recognizing a writing intention of the contents, and an advertisement selection unit for excluding the selected advertisement for the contents or selecting an alternative advertisement depending on the result of the analyzed context, the result of the analyzed sentiment object and sentiment information and the recognized writing intention.

### CROSS-REFERENCE(S) TO RELATED APPLICATIONS

The present invention claims priority of Korean Patent Application No. 10-2008-0126925, filed on Dec. 15, 2008, which is incorporated herein by reference.

### FIELD OF THE INVENTION

The present invention relates to an online advertisement service technology, and more particularly, to an apparatus and method for selecting an online advertisement and analyzing a public opinion based on a contents sentiment, which are suitable for recognizing sentiment and intention information of contents, and filtering off a corresponding advertisement or selecting an alternative advertisement so as to provide an online advertisement service.

### BACKGROUND OF THE INVENTION

Recently, a lot of studies have been conducted on a matching advertisement recommendation technology for use in performing an online advertisement service.

According to a conventional matching advertisement method, a method for generating an advertisement list based on score distribution judges the relation between advertisement information and a contents page using various scores, and prepares an advertisement list using advertisement information having close relation. This method performs determination of the advertisement information to be extracted for a context advertisement and position determination of the advertisement information in the list in consideration of various scores, thereby searches for the optimum advertisement information for contents details of the contents page and prepares the advertisement list.

In addition, another method automatically inserts one or more advertisements into a multiple page of a web site so that a web site provider can automatically provide the web site with commercial advertisements consistent with details of the web page. Here, appropriate advertisements are selected by classifying advertisements and web pages using predefined fields and keywords. The web site provider can selectively choose his/her field, and an advertiser can directly choose a field to which his/her advertisement is related.

In the conventional method for providing the online advertisement service operating as described above, since the advertisement appropriate for the web page is selected merely using the keywords and field information, its appropriateness is degraded. Also, since the advertisement related to details of the web page is outputted unconditionally, it may be outputted to contents having details against the advertiser.

### SUMMARY OF THE INVENTION

It is, therefore, an object of the present invention to provide an apparatus and method for selecting an online advertisement based on contents sentiment and intention analysis, which are capable of recognizing sentiment and intention information of contents, and filtering off an advertisement displayed to a user with the contents or automatically selecting an alternative advertisement so as to provide an online advertisement service.

Another object of the present invention is to provide an apparatus and method for selecting an online advertisement based on contents sentiment and intention analysis, which are capable of collecting contents corresponding to an advertisement target object, analyzing details of the collected contents to acquire sentiment information, recognizing a writing intention of the contents, analyzing a public opinion trend of the contents with respect to the advertisement target object, and providing an analyzed public opinion poll result so as to provide an online advertisement service.

In accordance with a first aspect of the present invention, there is provided an apparatus for selecting an online advertisement based on contents sentiment and intention analysis, the apparatus includes a context analysis unit for analyzing a context of contents, a context matching advertisement recommendation unit for selecting an advertisement matching with the context of the contents from an advertisement database (DB) based on the result of the analyzed context, an sentiment information analysis unit for analyzing an sentiment object and sentiment information variously described in the contents based on the result of the analyzed context, an intention recognition unit for recognizing a writing intention of the contents, and an advertisement selection unit for excluding the selected advertisement for the contents or selecting an alternative advertisement depending on the result of the analyzed context, the result of the analyzed sentiment object and sentiment information and the recognized writing intention.

It is preferable that the context analysis unit converts the contents into a context-analyzable form, and analyzes an advertisement category and keyword, by referring to an advertisement language resource DB storing languages used in advertisements.

It is preferable that the sentiment information analysis unit obtains the sentiment information using an sentiment learning DB having distinguishable sentiments on the basis of the relation between words, senses and extracts an object which is the subject of the sentiment information and which has close relation to the advertisement from among various objects described in the contents, sets the order of importance of the extracted sentiment object in the corresponding contents, analyzes an sentiment feature shown in the context to obtain an sentiment result of the sentiment object, and determines and outputs the sentiment result of each sentiment object on the basis of the analyzed sentiment feature.

It is preferable that the intention recognition unit predicts the writing intention of the contents, and an intention of a reader reading the contents and a subsequent action of the reader reading the contents, using an intention learning DB in which intentions are judged based on the relation between words.

It is preferable that the result of the analyzed context includes a list of an advertisement category and an advertisement keyword.

It is preferable that the result of the analyzed sentiment object and sentiment information includes a list of a recognized sentiment object, and sentiment information or an sentiment feature shown in the context.

It is preferable that the recognized writing intention includes a list of any one of comment, information transfer, criticism, comparison, agreement and public information.

It is preferable that the advertisement selection unit outputs a rival advertisement of the selected advertisement or an alternative advertisement of the selected advertisement based on the result of the analyzed sentiment object and sentiment information and the recognized writing intention by referring to an advertisement DB including diverse advertisements, and outputs the advertisements as a list in the order in the advertisement DB.

It is preferable that the apparatus further includes an object contents collection unit for collecting only contents related to a specific object to recognize a public opinion trend for a specific advertisement target, and a trend analysis unit for outputting a public opinion analysis result and numeric marks of each opinion based on an sentiment trend and the writing intention of the contents, wherein the sentiment information analysis unit analyzes the sentiment trend of the collected contents by referring to an sentiment learning DB including preset sentiment words, and the intention recognition unit recognizes the writing intention of the contents by referring to an intention learning DB including intention words that can be contained in the writing intention of the collected contents.

It is preferable that the contents are multimedia information including text media and moving picture media.

In accordance with a second aspect of the present invention, there is provided a method for selecting an online advertisement based on contents sentiment and intention analysis, the method includes analyzing a context of contents, selecting an advertisement matching with the context of the contents from an advertisement DB based on the result of the analyzed context, analyzing an sentiment object and sentiment information variously described in the contents based on the result of the analyzed context, recognizing a writing intention of the contents, and excluding the selected advertisement for the contents or selecting an alternative advertisement depending on the result of the analyzed context, the result of the analyzed sentiment object and sentiment information and the recognized writing intention.

It is preferable that said analyzing a context of contents converts the contents into a context-analyzable form, and analyzes an advertisement category and keyword by referring to an advertisement language resource DB storing languages used in advertisements.

It is preferable that said analyzing an sentiment object and sentiment information includes recognizing the sentiment information using an sentiment learning DB having distinguishable sentiments on the basis of the relation between words, sensing and extracting an object which is the subject of the sentiment information and which has close relation to the advertisement from among various objects described in the contents, setting the order of importance of the extracted sentiment object in the corresponding contents, analyzing an sentiment feature shown in the context to obtain an sentiment result of the sentiment object, and determining and outputting the sentiment result of each sentiment object on the basis of the analyzed sentiment feature.

It is preferable that said recognizing a writing intention of the contents predicts the writing intention of the contents, and an intention of a reader reading the contents and a subsequent action of the reader reading the contents, using an intention learning DB in which intentions are judged based on the relation between words.

It is preferable that the result of the analyzed context includes a list of an advertisement category and an advertisement keyword.

It is preferable that the result of the analyzed sentiment object and sentiment information includes a list of a recognized sentiment object, and sentiment information or an sentiment feature shown in the context.

It is preferable that the analyzed writing intention includes a list of any one of comment, information transfer, criticism, comparison, agreement and public information.

It is preferable that said excluding the selected advertisement includes outputting a rival advertisement of the selected advertisement or an alternative advertisement of the selected advertisement based on the result of the analyzed sentiment object and sentiment information and the recognized writing intention by referring to the advertisement DB including diverse advertisements, and outputting the advertisements as a list in the order in the advertisement DB.

It is preferable that the method further includes collecting only contents related to a specific object to recognize a public opinion trend for a specific advertisement target, and analyzing an sentiment trend of the collected contents by referring to an sentiment learning DB including preset sentiment words, recognizing the writing intention of the contents by referring to an intention learning DB including intention words that can be contained in the writing intention of the collected contents, and outputting a public opinion analysis result and numeric marks of each opinion based on the sentiment trend and the writing intention of the contents.

It is preferable that the contents are multimedia information including text media and moving picture media.

### BRIEF DESCRIPTION OF THE DRAWINGS

The above and other objects and features of the present invention will become apparent from the following description of preferred embodiments, given in conjunction with the accompanying drawings, in which:

FIG. 1 shows a structure of an apparatus for selecting an online advertisement based on contents sentiment and intention analysis in accordance with an embodiment of the present invention;

FIG. 2 is a flowchart illustrating an operation procedure of an apparatus for selecting an online advertisement in accordance with an embodiment of the present invention;

FIG. 3 illustrates a method for recommending an advertisement matching with a contents context in accordance with an embodiment of the present invention;

FIG. 4 describes a method for filtering off a specific advertisement in accordance with an embodiment of the present invention;

FIG. 5 illustrates a method for selecting an advertisement in accordance with an embodiment of the present invention; and

FIG. 6 depicts a flowchart illustrating a procedure for analyzing a public opinion trend with respect to an advertisement object in accordance with an embodiment of the present invention.

### DETAILED DESCRIPTION OF THE EMBODIMENTS

Hereinafter, the operational principle of the present invention will be explained in detail with reference to the accompanying drawings. In the following description, well-known constitutions or functions will not be described in detail if they would obscure the invention in unnecessary detail. Further, the terminologies to be described below are defined in consideration of functions in the present invention and may vary depending on a user's or operator's intention or practice. Thus, the definitions should be understood based on all the contents of the specification.

As will be described below, the present invention recognizes sentiment and intention information of contents, and filters off an advertisement displayed to a user with the contents or automatically selects an alternative advertisement so as to provide an online advertisement service. More specifically, the present invention provides a technology capable of maximizing an advertisement exposure effect by collecting contents corresponding to an advertisement target object, analyzing details of the collected contents to obtain sentiment information, recognizing a writing intention of the contents, analyzing a public opinion trend of the contents with respect to the advertisement target object, and filtering off an advertisement of the target object or choosing and recommending an alternative advertisement appropriate for the intention, when the public opinion trend of the contents with respect to the advertisement target object is negative.

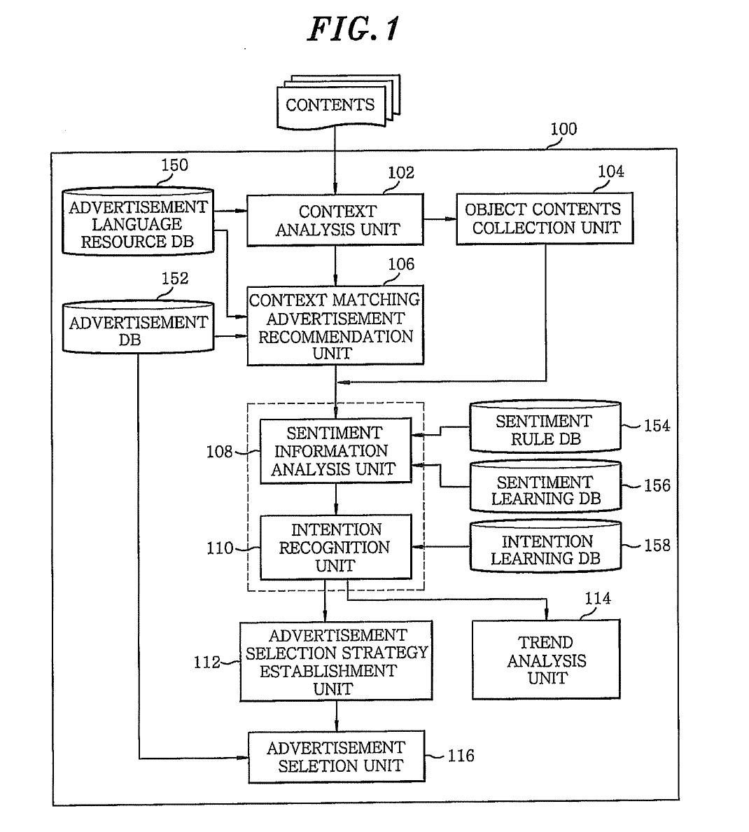

FIG. 1 is a block diagram illustrating a configuration of an apparatus for selecting an online advertisement based on contents sentiment and intention analysis in accordance with an embodiment of the present invention.

Referring to FIG. 1, the apparatus 100 for selecting the online advertisement includes a context analysis unit 102, an object contents collection unit 104, a context matching advertisement recommendation unit 106, an sentiment information analysis unit 108, an intention recognition unit 110, an advertisement selection strategy establishment unit 112, an advertisement selection unit 116, a trend analysis unit 114, and a database (DB) unit (not shown). Here, the DB unit includes an advertisement language resource DB 150, an advertisement DB 152, an sentiment rule DB 154, an sentiment learning DB 156, and an intention learning DB 158.

To be more specific, the apparatus 100 for selecting the online advertisement can be used in a special portal site or web site and a real-time broadcasting such as IPTV, and sets a search range in a web site, searches for all contents in the set range, and analyzes the searched contents.

The context analysis unit 102 refines valuable contents from various media (not only text media such as newspaper article, blog and product review but also multimedia such as user created contents (UCC) and moving picture, which may be all online contents including a web site and real-time broadcasting, which are set by a user, and a web site and real-time broadcasting, which require analysis) searched for or inputted via the apparatus 100 for selecting the online advertisement, i.e., converts the contents into a context-analyzable contents form. It then conducts context analysis such as hyper language processing, advertisement category classification, advertisement keyword analysis and so on, by referring to the advertisement language resource DB 150 in which languages used in advertisements are preset and stored.

The analysis result of the context analysis unit 102 is transferred to the context matching advertisement recommendation unit 106, which selects an advertisement most appropriate for the context of the given contents from the advertisement DB 152. Here, the selected advertisements are extracted regardless of an intention of the contents, and may include advertisements reducing an advertisement exposure effect.

Thereafter, on the basis of the analysis result of the context matching advertisement recommendation unit 106, the sentiment information analysis unit 108 selects various sentiment objects expressed in the contents and automatically recognizes sentiment information of the corresponding objects, using the sentiment learning DB 156 having distinguishable sentiments on the basis of the relation between words so as to recognize an sentiment of the contents. At this time, it is possible to reflect sentiment information which is sensitive to fashion or newly made hurriedly, by referring to the sentiment rule DB 154 which is temporarily set by an administrator based on a given application. Here, the sentiment learning DB 156 and the sentiment rule DB 154 can be implemented as one sentiment DB depending on an implementation method.

More specifically, the sentiment information analysis unit 108 recognizes a target sentiment object and sentiment information via the sentiment rule DB 154 which is preset by the user, senses and extracts an object which is the subject of the sentiment information and which has close relation to the advertisement from among various objects described in the contents, using the sentiment learning DB 156, and sets the order of importance of the extracted sentiment object in the corresponding contents. In other words, since one content may include several sentiments, the sentiment information analysis unit 108 analyzes an sentiment feature shown in the context, sets the order of importance differently, and finally outputs a list of sentiment results of each sentiment object. Here, the highest ranking sentiment of each content can be set as a representative sentiment.

Next, the intention recognition unit 110 can recognize a writing intention of the contents using the intention learning DB 158 in which intentions are judged on the basis of the relation between words so as to recognize which intention the corresponding contents were prepared with respect to a specific object (e.g. at least one of the intentions such as criticism, comparison, agreement (approval), public information (propagation) and so on).

That is, the intention recognition unit 110 judges a writing intention of the contents and an intention of a reader reading the contents, and predicts a subsequent action of the reader reading the contents.

Therefore, the advertisement selection strategy establishment unit 112 establishes an advertisement selection strategy, i.e., filters off a target advertisement with respect to a negative article not to provide a preset advertisement, or selects an alternative advertisement capable of dealing with the negative article on the basis of the context analysis result, and the sentiment information and the intention recognition result information outputted from the sentiment information analysis unit 108 and the intention recognition unit 110.

That is, maintenance of the advertisement list selected by the context matching advertisement recommendation unit 106, and filtering or replacement of the selected advertisement are performed on the basis of the context analysis result including the advertisement category and advertisement keyword lists, the sentiment information analysis result including the sentiment object and sentiment information lists, and the intention analysis result deducing a result such as comment, information transfer, criticism, comparison, agreement (approval), public information (propagation) or the like.

When contents details interfering with the advertisement are not found by the sentiment analysis and intention recognition, the selected advertisement list is maintained as it is. When an element interfering with the advertisement such as discontent, demerit and discomfort is deduced as a result during the contents analysis, the interfering advertisement is selected from the selected advertisement list and excluded, or whether the advertisement is the one that can be inserted into the selected advertisement list contents is judged by each order filtering, and a judgment result list is outputted.

However, if there is no advertisement that can be inserted into the specific contents in the selected advertisement list, an advertisement of a competitive company or an alternative advertisement appropriate for an intention of the contents is selected and outputted as a list.

Thereafter, the advertisement selection unit 116 sorts an optimum advertisement from among the advertisements included in the advertisement DB 152 depending on the result made by the advertisement selection strategy establishment unit 112 on the basis of multidimensional information such as the context, sentiment and intention of the contents. At this time, in case where more than one advertisement are recommended, the advertisements are outputted as a list in the preset order (any one of the importance of contents, the creation date of contents and the setting order of each word). Here, the advertisement selection strategy establishment unit 112 and the advertisement selection unit 116 may be one advertisement selection unit for establishing an advertisement selection strategy and selecting an advertisement at the same time depending on an implementation method.

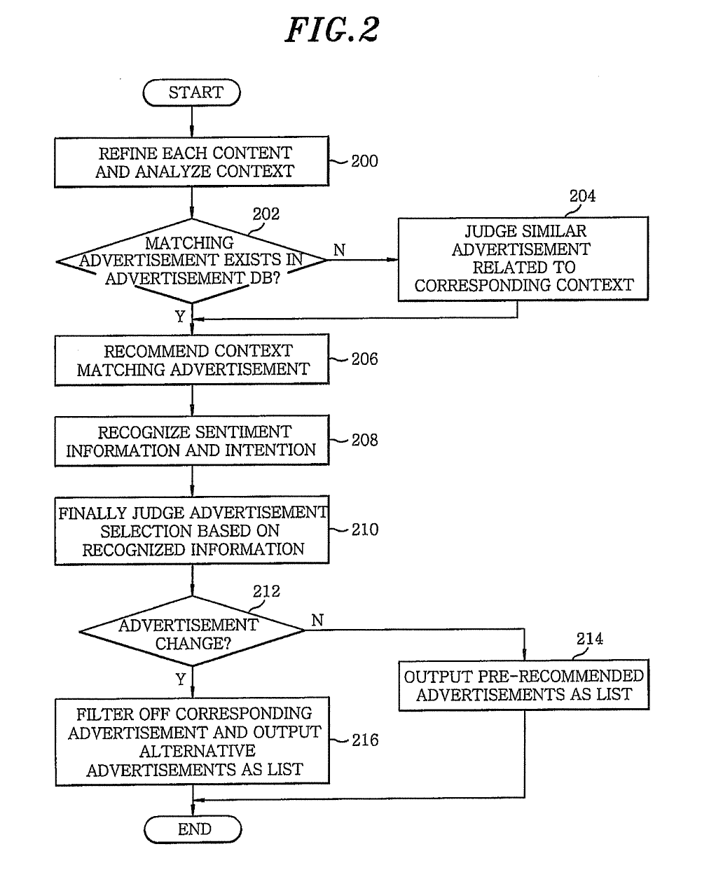

FIG. 2 is a flowchart illustrating an operation procedure of an apparatus for selecting an online advertisement in accordance with an embodiment of the present invention.

Referring to FIG. 2, at step 200, the context analysis unit 102 refines each input content and conducts its context analysis. At step 202, a context matching advertisement recommendation unit 106 searches the advertisement DB 152 for an advertisement most appropriate for the analyzed context of the contents. If such an advertisement exists, the procedure goes to step 206. However, if the advertisement appropriate for the analyzed context of the contents does not exist, at step 204, a similar advertisement related to the corresponding context is selected. At step 206, the advertisement related to the corresponding context is recommended, i.e., selected and outputted. When more than one advertisement are selected, a selected advertisement list is outputted.

Here, the selected advertisement list can be provided in the order. The advertisement DB 152 provides information having the order of each advertisement unit price and advertisement importance on the basis of information of each specific object and word which are stored in the order in the advertisement language resource DB 150.

Then, at step 208, on the basis of the context matching result, the sentiment information analysis unit 108 and the intention recognition unit 110 recognize a target object and sentiment information of the contents, analyze an object which is the subject, output an sentiment analysis result list of the corresponding contents, recognize preparation and next action intentions of the contents, and output an intention recognition result list.

Next, at step 210, a strategy for final advertisement selection is established on the basis of the sentiment analysis result list and the intention recognition result list. At the advertisement selection unit 116, at step 212, when it is necessary to change the selected advertisement on the basis of the finally-established strategy, the procedure goes to step 216, which filters off the corresponding advertisement, selects an alternative advertisement appropriate for the intention of the contents and an advertisement of a competitive company, and outputs them as a list. On the other hand, at step 212, when it is judged that the selected advertisement is appropriate, the procedure goes to step 214 to output the previously selected advertisements as a list.

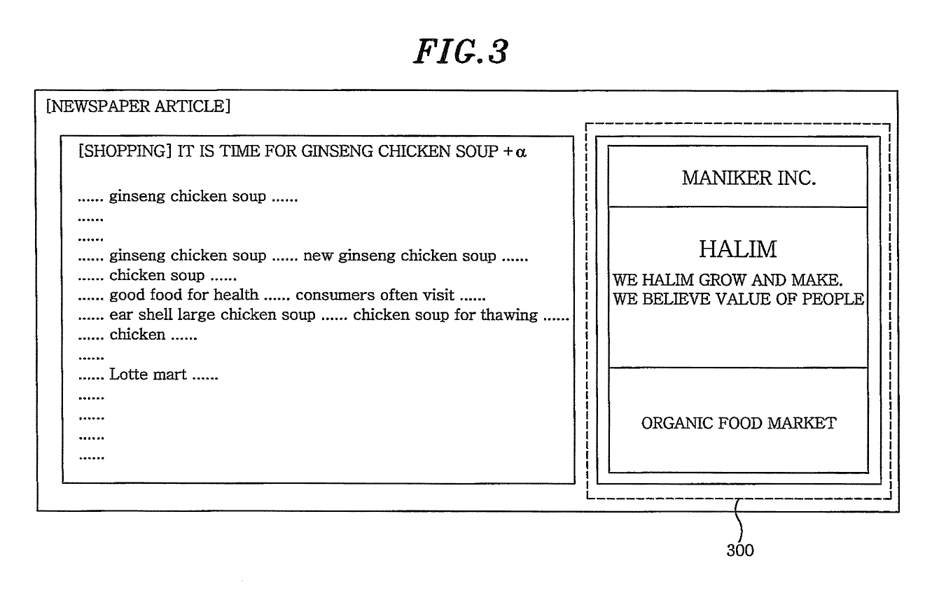

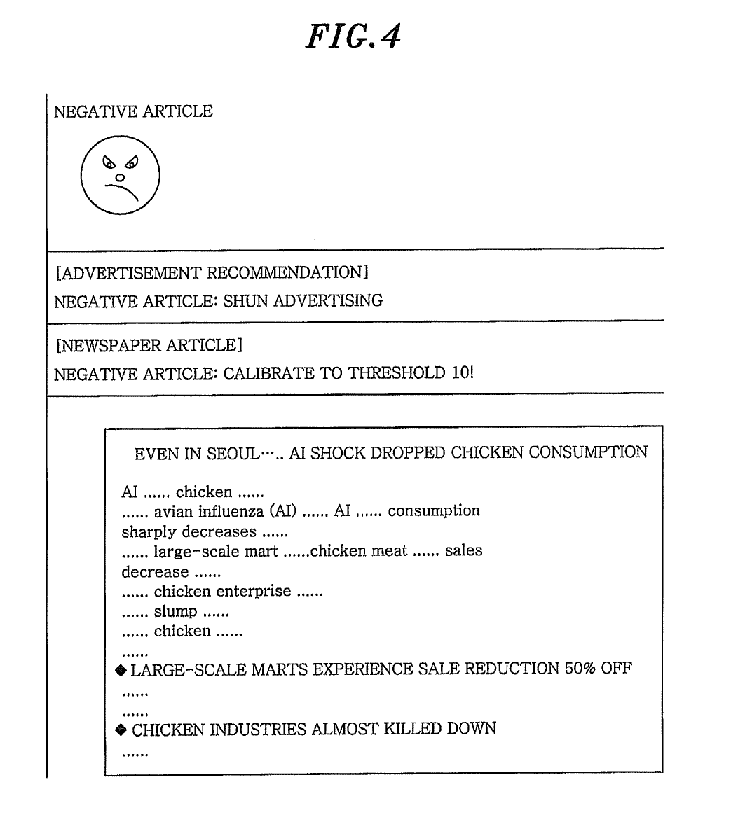

FIGS. 3 and 4 show an embodiment suggesting an online advertisement to a newspaper article medium, using an apparatus for selecting an advertisement based on sentiment and intention analysis. Two documents are newspaper articles associated with ‘Food>Livestock Product>Chicken’.

FIG. 3 illustrates a method for recommending an advertisement matching with a contents context in accordance with an embodiment of the present invention. The newspaper article entitled by ‘Ginseng chicken soup +’ suggests advantages of the ginseng chicken soup which is a summer health preservation food, and introduces a new ginseng chicken soup, an analysis result of which is as follows. A final advertisement list selected from the advertisement DB on the basis of the multidimensional analysis result is indicated by reference numeral 300.

Therefore, advertisements of companies or products mentioned in the article are determined to be inserted into reference numeral 300.

### 1) Context Analysis Result of the Context Analysis Unit 102

Advertisement category: Food>Livestock Product>Chicken
Advertisement keywords: Ginseng chicken soup, Chicken, Chicken juice, Ear shell large chicken soup, Chicken soup for thawing, Lotte mart, etc.

### 2) Sentiment Information Analysis Result of the Sentiment Information Analysis Unit 108

Ginseng chicken soup—Positive (Clue: Good food for health)
Health preservation food Positive (Clue: Consumers often visit)
Lotte mart—Positive (Clue: Sales sharply increase)
General chicken—Negative (Flesh is more or less tough)
Farm chicken—Positive (Flesh is chewy)

### 3) Intention Analysis Result of the Intention Recognition Unit 110

Information transfer
Public information

FIG. 4 illustrates a method for filtering off a specific advertisement in accordance with an embodiment of the present invention.

Referring to FIG. 4, a newspaper article entitled by ‘Even In Seoul - - - AI shock dropped chicken consumption’ analyzes a movement of a chicken market suddenly changed due to AI, an analysis result of which is as follows. Since it is judged from an sentiment information analysis result that this article is negative to ‘Chicken’ and ‘Discount store’ which sells chicken, which are main targets of an advertisement, advertisements are filtered off.

That is, this article includes negative article details as well as words such as ‘AI’, ‘Slump’ and ‘Dullness’, and thus, advertisements related to chicken and large-scale marts are filtered off not to be inserted, and no advertisement is inserted. If there is an advertisement involving a specific negative word, an AI-related ensuring advertisement for example is inserted.

### 1) Context Analysis Result of the Context Analysis Unit 102

Advertisement category: Food>Livestock Product>Chicken
Advertisement keywords: AI, Chicken, Chicken meat, Large-scale mart

### 2) Sentiment Information Analysis Result of the Sentiment Information Analysis Unit 108

Chicken—Negative (Clue: Consumption sharply decreases)
Large-scale mart—Negative (Clue: Sales decrease)
Chicken enterprise—Negative (Clue: Almost killed down)

### 3) Intention Analysis Result of the Intention Recognition Unit 110

Information transfer
Damage analysis

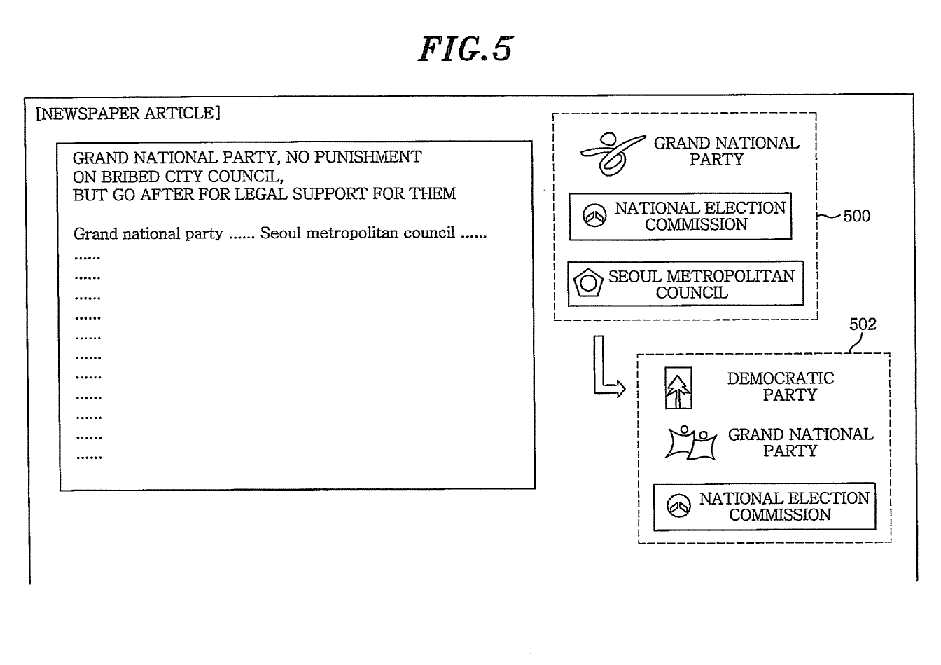

FIG. 5 illustrates a method for selecting an advertisement in accordance with an embodiment of the present invention.

Referring to FIG. 5, with respect to a newspaper article entitled by ‘Grand national party, no punishment on bribed city council, but go after legal support for them’ from the contents to be posted on a web site, advertisements are filtered off and other alternative advertisements are selectively provided to maximize an advertisement effect.

With respect to this newspaper article, the context matching advertisement recommendation unit 106 selects advertisements of ‘Grand national party’ and ‘Seoul metropolitan council’ like an advertisement list 500. However, as an analysis result of the sentiment information analysis unit 108, since details of the article disclose corruption of a specific political party, this article is negative to the corresponding political party (Grand national party) and the organization (Seoul metropolitan council) involved with corruption, but profitable for rival political parties of the corresponding political party. Therefore, the advertisement selection strategy establishment unit 112 establishes a strategy of replacing advertisements of ‘Grand national party’ and ‘Seoul municipal assembly’ with advertisements of rival political parties such as ‘Democratic party’ or ‘Liberty forward party’ in the advertisement list 500 selected by the context matching advertisement recommendation unit 106, and the advertisement selection unit 116 exposes a final advertisement list 502 including the advertisements determined by advertisement selection strategy establishment unit 112.

Meanwhile, the apparatus 100 for selecting an online advertisement can also be used for public opinion analysis of a specific target as well as an online matching advertisement service.

That is, only contents related to an advertisement target or a target object for public opinion analysis can be picked out from contents analyzed by the object contents collection unit 104 and the context analysis unit 102 of the apparatus 100 for selecting the online advertisement.

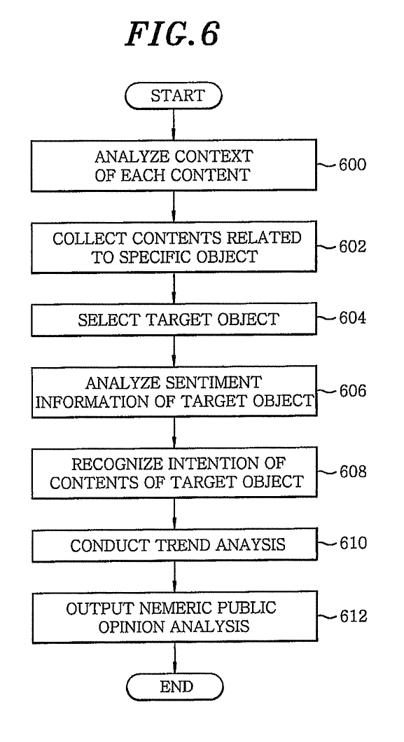

The trend analysis unit 114 can analyze a public opinion trend of a specific object based on an execution result of the sentiment information analysis unit 108 and the intention recognition unit 110 on the sorted contents, e.g., analyze information such as ‘Good or bad article for a specific enterprise’ or ‘Preference for a bubble-type washing machine’, details of which will be given below with reference to FIG. 6.

FIG. 6 is a flowchart illustrating a procedure for analyzing a public opinion trend with respect to an advertisement object in accordance with an embodiment of the present invention.

Referring to FIG. 6, a public opinion trend analysis result of a target object which is a specific advertisement target (e.g., a newly-released electric home appliance ‘Bubble-type washing machine’) is obtained, using the apparatus 100 for selecting an online advertisement based on sentiment and intention analysis. To this end, at step 600, the context analysis unit 102 conducts context analysis on each content, and at step 602, the object contents collection unit 104 separately collects contents related to the specific object based on context information analyzed by the context analysis unit 102, and stores the collected contents. However, it is not essential to separately collect the respective related contents, but may be possible to pick out only the contents related to the specific object in function and use them as input of sentiment and trend analysis based on an implementation method.

Then, in case where a target object is selected by a user or operator at step 604, contents related to ‘Bubble-type washing machine’ are selected from the target contents, and only contents including opinions related to ‘Bubble-type washing machine’ are extracted from the contents stored in the object contents collection unit 104. At step 606, the sentiment information analysis unit 108 analyzes sentiment information of the target object, and at step 608, the intention recognition unit 610 recognizes an intention of the contents of the target object, thereby providing a public opinion analysis result as a multidimensional context analysis result. Thereafter, at step 610, the trend analysis unit 114 conducts trend analysis for collectively combining opinions for the corresponding target object, such as approval/disapproval, like/dislike and merit/demerit, on the basis of the multidimensional context analysis result. At step 612, a numerical public opinion analysis result is finally outputted.

At this time, the trend analysis unit 114 can perform re-ordering of the contents such that opinions for the newly-created contents are positioned in a high rank from a creation time point of the contents through the starting date of the contents selected by the sentiment and intention context analysis, extract merit/demerit, approval/disapproval, like/dislike, preferred function, and comfort/discomfort from the contents with respect to the specific object, and provide numerical marks in each opinion based on the above results, thereby performing trend analysis and public opinion analysis to provide the user with more exact information.

For example, when merits and demerits of a specific object are expressed as numerical marks, if the merits are suggested in seven opinions and the demerits are suggested in three opinions, marks can be 7.0 from full marks of 10, and a star grade can be 3.5 from a perfect grade of 5.

An exemplary public opinion analysis result can be represented by the following Table 1.

TABLE 1
Bubble-type washing machine

| | |
|---|---|
| Analysis period: | Jan. 1, 2008 to Jun. 31, 2008 |
| Marks: | 6.8 |
| Merits: | Clean, Quiet, Visible, . . . |
| Demerits: | Long time, Difficult to operate, . . . |

The result of Table 1 is transferred to an advertiser of ‘Bubble-type washing machine’, so that he/she can refer to this result in developing a product or determining a consumer dealing direction afterward.

As described above, the present invention can recognize sentiment and intention information of contents, and filter off an advertisement displayed to a user with the contents or automatically select an alternative advertisement so as to provide an online advertisement service. Specifically, the present invention can maximize an advertisement exposure effect by collecting contents corresponding to an advertisement target object, analyzing details of the collected contents to recognize sentiment information, recognizing a writing intention of the contents, analyzing a public opinion trend of the contents with respect to the advertisement target object, and filtering off an advertisement of the target object or choosing and recommending an alternative advertisement appropriate for the intention, when it is negative.

While the invention has been shown and described with respect to the embodiments, it will be understood by those skilled in the art that various changes and modification may be made.

What is claimed is:

1. An apparatus for selecting an online advertisement based on contents sentiment and intention analysis, the apparatus comprising:
a context analysis unit for analyzing a context of contents;
a context matching advertisement recommendation unit for selecting an advertisement matching with the context of the contents from an advertisement database (DB) based on the result of the analyzed context;
an sentiment information analysis unit for analyzing an sentiment object and sentiment information variously described in the contents based on the result of the analyzed context;
an intention recognition unit for recognizing a writing intention of the contents; and
an advertisement selection unit for excluding the selected advertisement for the contents or selecting an alternative advertisement depending on the result of the analyzed context, the result of the analyzed sentiment object and sentiment information and the recognized writing intention.

2. The apparatus of claim 1, wherein the context analysis unit converts the contents into a context-analyzable form, and analyzes an advertisement category and keyword, by referring to an advertisement language resource DB storing languages used in advertisements.

3. The apparatus of claim 1, wherein the sentiment information analysis unit obtains the sentiment information using an sentiment learning DB having distinguishable sentiments on the basis of the relation between words, senses and extracts an object which is the subject of the sentiment information and which has close relation to the advertisement from among various objects described in the contents, sets the order of importance of the extracted sentiment object in the corresponding contents, analyzes an sentiment feature shown in the context to obtain an sentiment result of the sentiment object, and determines and outputs the sentiment result of each sentiment object on the basis of the analyzed sentiment feature.

4. The apparatus of claim 1, wherein the intention recognition unit predicts the writing intention of the contents, and an intention of a reader reading the contents and a subsequent action of the reader reading the contents, using an intention learning DB in which intentions are judged based on the relation between words.

5. The apparatus of claim 1, wherein the result of the analyzed context includes a list of an advertisement category and an advertisement keyword.

6. The apparatus of claim 1, wherein the result of the analyzed sentiment object and sentiment information includes a list of a recognized sentiment object, and sentiment information or an sentiment feature shown in the context.

7. The apparatus of claim 1, wherein the recognized writing intention includes a list of any one of comment, information transfer, criticism, comparison, agreement and public information.

8. The apparatus of claim 1, wherein the advertisement selection unit outputs a rival advertisement of the selected advertisement or an alternative advertisement of the selected advertisement based on the result of the analyzed sentiment object and sentiment information and the recognized writing intention by referring to an advertisement DB including diverse advertisements, and outputs the advertisements as a list in the order in the advertisement DB.

9. The apparatus of claim 1, further comprising:
an object contents collection unit for collecting only contents related to a specific object to recognize a public opinion trend for a specific advertisement target; and
a trend analysis unit for outputting a public opinion analysis result and numeric marks of each opinion based on an sentiment trend and the writing intention of the contents,
wherein the sentiment information analysis unit analyzes the sentiment trend of the collected contents by referring to an sentiment learning DB including preset sentiment words, and
the intention recognition unit recognizes the writing intention of the contents by referring to an intention learning DB including intention words that can be contained in the writing intention of the collected contents.

10. The apparatus of claim 1, wherein the contents are multimedia information including text media and moving picture media.

11. A method for selecting an online advertisement based on contents sentiment and intention analysis, the method comprising:
analyzing a context of contents;
selecting an advertisement matching with the context of the contents from an advertisement DB based on the result of the analyzed context;
analyzing an sentiment object and sentiment information variously described in the contents based on the result of the analyzed context;
recognizing a writing intention of the contents; and
excluding the selected advertisement for the contents or selecting an alternative advertisement depending on the result of the analyzed context, the result of the analyzed sentiment object and sentiment information and the recognized writing intention.

12. The method of claim 11, wherein said analyzing a context of contents converts the contents into a context-analyzable form, and analyzes an advertisement category and keyword by referring to an advertisement language resource DB storing languages used in advertisements.

13. The method of claim 11, wherein said analyzing an sentiment object and sentiment information includes:
recognizing the sentiment information using an sentiment learning DB having distinguishable sentiments on the basis of the relation between words, sensing and extracting an object which is the subject of the sentiment information and which has close relation to the advertisement from among various objects described in the contents;
setting the order of importance of the extracted sentiment object in the corresponding contents;
analyzing an sentiment feature shown in the context to obtain an sentiment result of the sentiment object; and
determining and outputting the sentiment result of each sentiment object on the basis of the analyzed sentiment feature.

14. The method of claim 11, wherein said recognizing a writing intention of the contents predicts the writing intention of the contents, and an intention of a reader reading the contents and a subsequent action of the reader reading the contents, using an intention learning DB in which intentions are judged based on the relation between words.

15. The method of claim 11, wherein the result of the analyzed context includes a list of an advertisement category and an advertisement keyword.

16. The method of claim 11, wherein the result of the analyzed sentiment object and sentiment information includes a list of a recognized sentiment object, and sentiment information or an sentiment feature shown in the context.

17. The method of claim 11, wherein the analyzed writing intention includes a list of any one of comment, information transfer, criticism, comparison, agreement and public information.

18. The method of claim 11, wherein said excluding the selected advertisement includes:
outputting a rival advertisement of the selected advertisement or an alternative advertisement of the selected advertisement based on the result of the analyzed sentiment object and sentiment information and the recognized writing intention by referring to the advertisement DB including diverse advertisements; and
outputting the advertisements as a list in the order in the advertisement DB.

19. The method of claim 11, further comprising:
collecting only contents related to a specific object to recognize a public opinion trend for a specific advertisement target; and
analyzing an sentiment trend of the collected contents by referring to an sentiment learning DB including preset sentiment words;
recognizing the writing intention of the contents by referring to an intention learning DB including intention words that can be contained in the writing intention of the collected contents; and
outputting a public opinion analysis result and numeric marks of each opinion based on the sentiment trend and the writing intention of the contents.

20. The method of claim 11, wherein the contents are multimedia information including text media and moving picture media.
